(19) United States
(12) Patent Application Publication
(10) Pub. No.: US 2010/0278355 A1
(43) Pub. Date: Nov. 4, 2010

(54) Feedforward-Based ANR Adjustment Responsive to Environmental Noise Levels

(76) Inventor: Paul G. Yamkovoy, Acton, MA (US)

Correspondence Address: Bose Corporation;c/o Donna Griffiths, The Mountain, MS 40, IP Legal - Patent Support, Framingham, MA, 01701, US

(21) Appl. No.: 12/432,234

(22) Filed: Apr. 29, 2009

(51) Int. Cl. H04B 15/00

(52) U.S. Cl. 381/94.9

(57) ABSTRACT

A compression circuit of a device providing feedforward-based ANR monitors the electric signal output by a feedforward microphone for indications of the voltage levels of the electric signal output by the feedforward microphone ceasing to have a linear relationship with the acoustic levels of the sounds detected by the feedforward microphone. As long as there are no such indications, the compression circuit relays a signal to a feedforward anti-noise generator that is at least representative of the electric signal output by the feedforward microphone in which the sounds represented are not compressed, perhaps by directly relaying the signal output by the feedforward microphone as feedforward reference sounds. However, in response to detecting such indications, the compression circuit compresses the sounds represented by the signal output by the feedforward microphone prior to providing those sounds to the feedforward anti-noise generator as feedforward reference sounds, perhaps by attenuating the signal output by the feedforward microphone.

### TECHNICAL FIELD

This disclosure relates to personal active noise reduction (ANR) devices to reduce acoustic noise in the vicinity of at least one of a user's ears.

### BACKGROUND

Headphones and other physical configurations of personal ANR device worn about the ears of a user for purposes of isolating the user's ears from unwanted environmental sounds have become commonplace. In particular, ANR headphones in which unwanted environmental noise sounds are countered with the active generation of anti-noise sounds have become very prevalent, even in comparison to headphones or ear plugs employing only passive noise reduction (PNR) technology, in which a user's ears are simply physically isolated from environmental noises.

Unfortunately, despite various improvements made over time, existing personal ANR devices continue to suffer from a variety of drawbacks, especially in situations involving environmental noise at very high levels. As will be familiar to those skilled in the art, microphones are generally able to provide an electrical output representative of the sounds they detect with a high degree of linearity between the acoustic level of the detected sounds and the voltage levels of resulting electrical output. However, ever microphone has a maximum acoustic level that when exceeded, results in the microphone providing an electrical output that is no longer linear, and indeed, is often clipped at a maximum voltage level that the microphone is unable to exceed with its electrical output.

Where a microphone is incorporated into an ANR device as a feedforward microphone such that it is acoustically coupled to the surrounding environment to detect noise sounds as a reference input for feedforward-based ANR, instances of clipping of that microphone's electrical output due to very high environmental noise levels can defeat the effectiveness of the feedforward-based ANR. More particularly, since the electrical output of such a microphone serves as the basis for the generation of anti-noise sounds, instances of clipping in that electrical output can actually cause a feedforward-based ANR to generate more noise than it reduces. Thus, continued use of feedforward-based ANR where there are environmental noise sounds at high acoustic levels can actually bring about a worse result than not using feedforward-based ANR.

### SUMMARY

A compression circuit of a device providing feedforward-based ANR monitors the electric signal output by a feedforward microphone for indications of the voltage levels of the electric signal output by the feedforward microphone ceasing to have a linear relationship with the acoustic levels of the sounds detected by the feedforward microphone. As long as there are no such indications, the compression circuit relays a signal to a feedforward anti-noise generator that is at least representative of the electric signal output by the feedforward microphone in which the sounds represented are not compressed, perhaps by directly relaying the signal output by the feedforward microphone as feedforward reference sounds. However, in response to detecting such indications, the compression circuit compresses the sounds represented by the signal output by the feedforward microphone prior to providing those sounds to the feedforward anti-noise generator as feedforward reference sounds, perhaps by attenuating the signal output by the feedforward microphone.

In one aspect, a method of providing feedforward-based ANR in an earpiece of a personal ANR device includes monitoring a voltage level of an electric signal output by a feedforward microphone disposed on an external portion of the personal ANR device, wherein the electric signal is representative of environmental noise sounds detected by the feedforward microphone; providing the environmental noise sounds detected by the feedforward to a feedforward anti-noise generator as feedforward reference sounds to provide the feedforward-based ANR; and compressing the environmental noise sounds prior to providing the environmental noise sounds to the anti-noise generator in response to peaks in the voltage level of the electric signal output by the feedforward microphone reaching a predetermined voltage level.

Implementations may include, and are not limited to, one or more of the following features. Monitoring the electric signal may include providing the electric signal to an envelope detector comprising a peak detector and an integrator. Compressing the environmental noise sounds may include triggering the compressing of the environmental noise sounds based on the voltage level of the output of the envelope detector, and reducing the voltage level of the electric signal output by the feedforward microphone. The method may further include selecting the predetermined voltage level to trigger the compressing of the environmental sounds during instances of clipping of the electric signal. The method may further include converting the electric signal output by the feedforward microphone into digital data that is representative of the environmental noise sounds detected by the feedforward microphone. Further, compressing the environmental noise sounds may include triggering the compressing of the environmental noise sounds based on the digital data providing indication of peaks in the voltage level of the electric output reaching the predetermined voltage level, and altering the digital data to compress the environmental noise sounds represented by the digital data prior to the digital data being employed in generating feedforward anti-noise sounds.

In one aspect, an apparatus includes an ANR circuit, and the ANR circuit includes a feedforward anti-noise generator to generate feedforward anti-noise sounds as part of providing feedforward-based ANR, and a compression circuit to monitor an electric signal output by a feedforward microphone that is representative of environmental noise sounds detected by the feedforward microphone, and to compress the environmental noise sounds prior to providing the environmental noise sounds to the anti-noise generator as feedforward reference sounds in response to peaks in a voltage level of the electric signal.

Implementations may include, and are not limited to, one or more of the following features. The ANR circuit may further include a peak detector to store a voltage level of a peak of the electric signal and an integrator to provide an output representing an integral of a plurality of peaks of the electric signal. The ANR circuit may still further include a comparator to compare voltage levels including a voltage level of a threshold voltage that is dynamically configurable to enable a voltage level of a peak in the electric signal that triggers compression to be dynamically configured to accommodate a changing of the feedforward microphone. Alternatively and/or additionally, the ANR circuit may still further include an amplifier to which the output of the integrator is provided, and provided with a variable gain that is dynamically configurable to enable a voltage level of a peak in the electric signal that triggers compression to be dynamically configured to accommodate a changing of the feedforward microphone.

The ANR circuit may still further include an ADC to convert the electric signal to digital data representative of the environmental noise sounds detected by the feedforward microphone, a processing device, and a storage in which is stored a sequence of instructions of a compression routine that when executed by the processing device, causes the processing device to alter the digital data to compress the environmental noise sounds represented by the digital data prior to the digital data being employed in generating feedforward anti-noise sounds. Also, the processing device may be further caused to generate the feedforward anti-noise sounds.

The apparatus may further include an earpiece, the feedforward microphone, an audio amplifier to amplify the feedforward anti-noise sounds generated by the feedforward anti-noise generator, and an acoustic driver disposed within the earpiece and coupled to the audio amplifier to acoustically output the feedforward anti-noise sounds. The apparatus may still further include a feedback microphone disposed within the earpiece, a feedback anti-noise generator to generate feedback anti-noise from sounds detected by the feedback microphone, and a summing node to combine the feedforward anti-noise sounds and the feedback anti-noise sounds to be acoustically output by the acoustic driver.

Other features and advantages of the invention will be apparent from the description and claims that follow.

### DESCRIPTION OF THE DRAWINGS

FIGS. 1a and 1b are block diagrams of portions of personal ANR devices.

FIGS. 2a and 2b depict possible physical configurations of the personal ANR devices of FIGS. 1a and 1b.

FIG. 3a depicts a possible internal architecture of an ANR circuit of the personal ANR device of FIG. 1a.

FIG. 3b depicts a possible internal architecture of an ANR circuit of the personal ANR device of FIG. 1b.

FIGS. 4a through 4c depict possible internal architectures of a compression circuit of either of the internal architectures of FIGS. 3a and 3b.

### DETAILED DESCRIPTION

What is disclosed and what is claimed herein is intended to be applicable to a wide variety of personal ANR devices, i.e., devices that are structured to be at least partly worn by a user in the vicinity of at least one of the user's ears to provide ANR functionality for at least that one ear. It should be noted that although various specific embodiments of personal ANR devices, such as headphones and wireless earphones are presented with some degree of detail, such presentations of specific embodiments are intended to facilitate understanding through the use of examples, and should not be taken as limiting either the scope of disclosure or the scope of claim coverage.

It is intended that what is disclosed and what is claimed herein is applicable to personal ANR devices that provide two-way audio communications, one-way audio communications (i.e., acoustic output of audio electronically provided by another device), or no communications, at all. It is intended that what is disclosed and what is claimed herein is applicable to personal ANR devices that are wirelessly connected to other devices, that are connected to other devices through electrically and/or optically conductive cabling, or that are not connected to any other device, at all. It is intended that what is disclosed and what is claimed herein is applicable to personal ANR devices having physical configurations structured to be worn in the vicinity of either one or both ears of a user, including and not limited to, headphones with either one or two earpieces, over-the-head headphones, behind-the-neck headphones, headsets with communications microphones (e.g., boom microphones), wireless headsets (i.e., earsets), single earphones or pairs of earphones, as well as hats or helmets incorporating one or two earpieces to enable audio communications and/or ear protection. Still other physical configurations of personal ANR devices to which what is disclosed and what is claimed herein are applicable will be apparent to those skilled in the art.

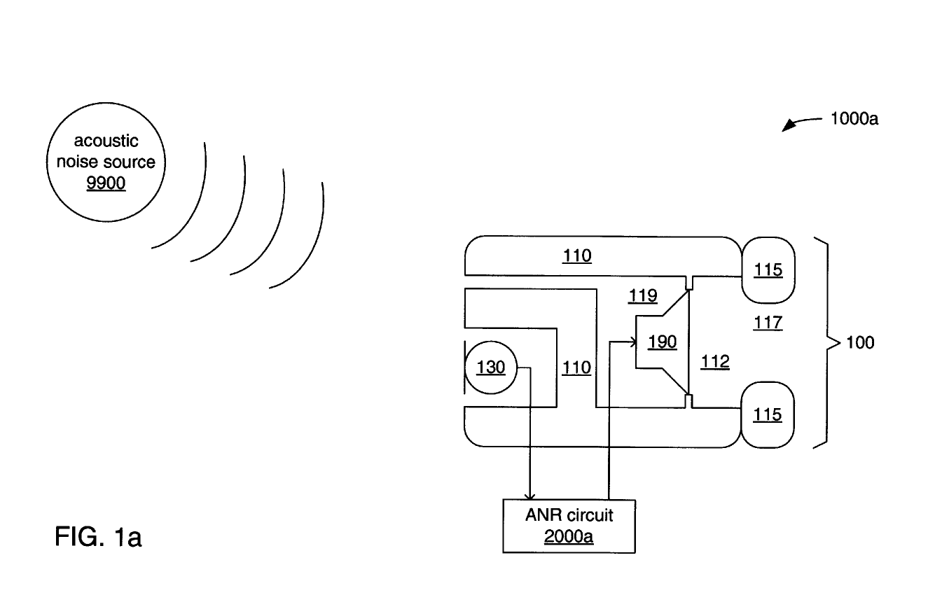

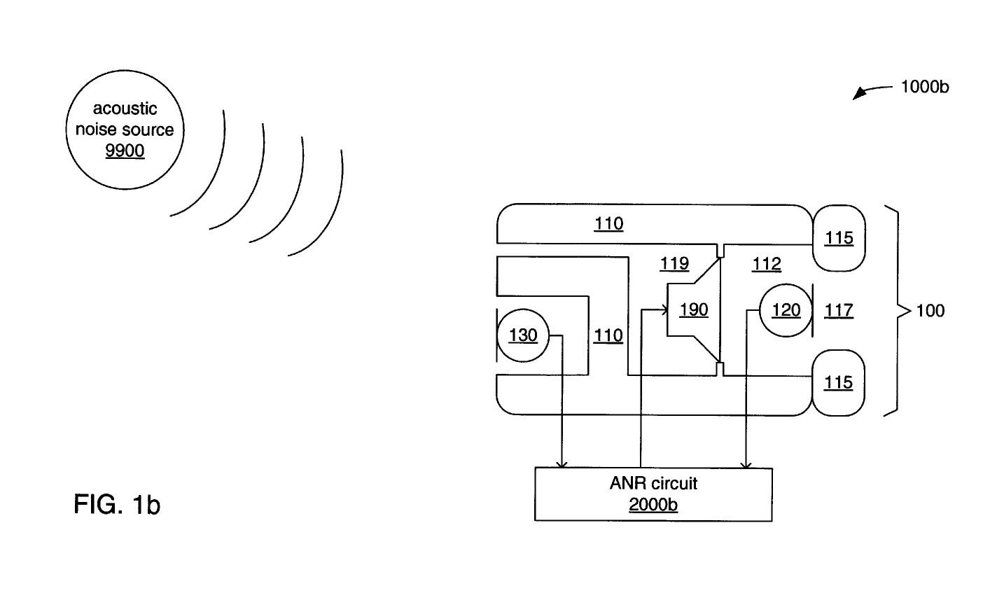

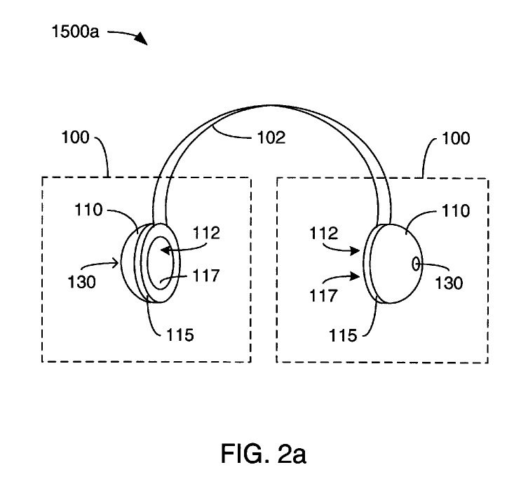

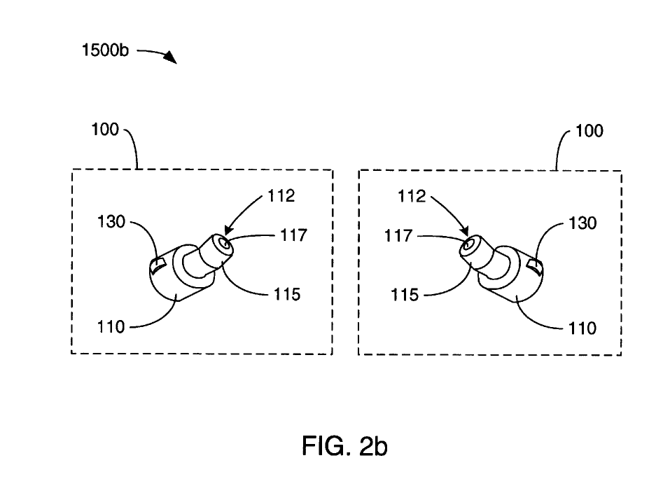

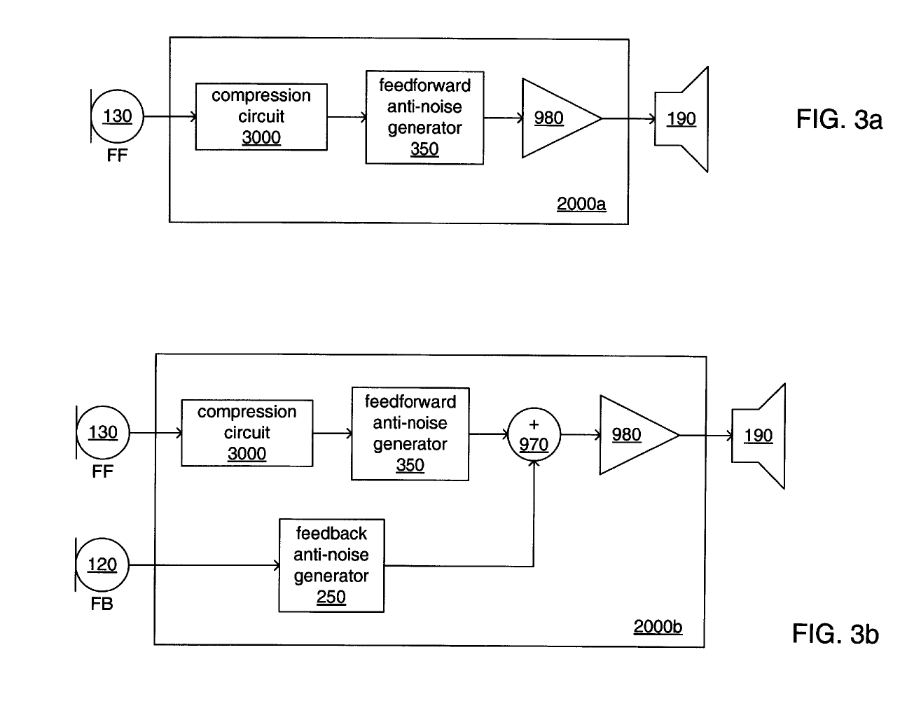

FIGS. 1a and 1b provide block diagrams of personal ANR devices 1000a and 1000b, respectively, each of which is structured to be worn by a user to provide active noise reduction (ANR) in the vicinity of at least one of the user's ears. As will be explained in greater detail, each of the personal ANR devices 1000a and 1000b may have any of a number of physical configurations, possible ones of which are depicted in FIGS. 2a and 2b. Some possible physical configurations may incorporate a single earpiece 100 to provide ANR to only one of the user's ears, and others incorporate a pair of earpieces 100 to provide ANR to both of the user's ears. However, it should be noted that for the sake of simplicity of discussion, only a single earpiece 100 is depicted and described in relation to each of FIGS. 1a and 1b. The personal ANR device 1000a incorporates at least one ANR circuit 2000a that provides feedforward-based ANR, and the personal ANR device 1000b incorporates at least one ANR circuit 2000b that provides both feedforward-based and feedback-based ANR. The provision of whatever form of ANR by each of the personal ANR devices 1000a and 1000b may be in addition to the provision of some form of passive noise reduction (PNR) provided by the structure of each earpiece 100. FIG. 3a depicts the internal architecture of the ANR circuit 2000a, and FIG. 3b depicts the internal architecture of the ANR circuit 2000b.

Each earpiece 100 incorporates a casing 110 having a cavity 112 at least partly defined by the casing 110 and by at least a portion of an acoustic driver 190 disposed within the casing to acoustically output at least ANR anti-noise sounds to a user's ear. This manner of positioning the acoustic driver 190 also partly defines another cavity 119 within the casing 110 that is separated from the cavity 112 by the acoustic driver 190. The casing 110 carries an ear coupling 115 surrounding an opening to the cavity 112 and having a passage 117 that is formed through the ear coupling 115 and that communicates with the opening to the cavity 112. In some embodiments, an acoustically transparent screen, grill or other form of perforated panel (not shown) may be positioned in or near the passage 117 in a manner that obscures the cavity and/or the passage 117 from view for aesthetic reasons and/or to protect components within the casing 110 from damage. At times when the earpiece 100 is worn by a user in the vicinity of one of the user's ears, the passage 117 acoustically couples the cavity 112 to the ear canal of that ear, while the ear coupling 115 engages portions of the ear to form at least some degree of acoustic seal therebetween. This acoustic seal enables the casing 110, the ear coupling 115 and portions of the user's head surrounding the ear canal (including portions of the ear) to cooperate to acoustically isolate the cavity 112, the passage 117 and the ear canal from the environment external to the casing 110 and the user's head to at least some degree, thereby providing some degree of PNR.

In some variations, the cavity 119 may be coupled to the environment external to the casing 110 via one or more acoustic ports (only one of which is shown), each tuned by their dimensions to a selected range of audible frequencies to enhance characteristics of the acoustic output of sounds by the acoustic driver 190 in a manner readily recognizable to those skilled in the art. Also, in some variations, one or more tuned ports (not shown) may couple the cavities 112 and 119, and/or may couple the cavity 112 to the environment external to the casing 110. Although not specifically depicted, screens, grills or other forms of perforated or fibrous structures may be positioned within one or more of such ports to prevent passage of debris or other contaminants therethrough and/or to provide a selected degree of acoustic resistance therethrough.

A feedforward microphone 130 is disposed on the exterior of the casing 110 (or on some other portion of either of the personal ANR devices 1000a or 1000b) in a manner that is acoustically accessible to the environment external to the casing 110. This external positioning of the feedforward microphone 130 enables the feedforward microphone 130 to detect environmental noise sounds, such as those emitted by an acoustic noise source 9900, in the environment external to the casing 110 without the effects of any form of PNR or ANR that are provided. As those familiar with feedforward-based ANR will readily recognize, these sounds detected by the feedforward microphone 130 are used as a reference from which feedforward anti-noise sounds are derived and then acoustically output into the cavity 112 by the acoustic driver 190. The derivation of the feedforward anti-noise sounds takes into account the characteristics of whatever PNR is provided, characteristics and position of the acoustic driver 190 relative to the feedforward microphone 130, and/or acoustic characteristics of the cavity 112 and/or the passage 117. The feedforward anti-noise sounds are acoustically output by the acoustic driver 190 with amplitudes and time shifts calculated to acoustically interact with the noise sounds of the acoustic noise source 9900 that are able to enter into the cavity 112, the passage 117 and/or an ear canal in a subtractive manner that at least attenuates them.

The personal ANR device 1000b provides feedback-based ANR in addition to feedforward-based ANR. Thus, in the personal ANR device 1000b, a feedback microphone 120 is additionally disposed within the cavity 112. The feedback microphone 120 is positioned in close proximity to the opening of the cavity 112 and/or the passage 117 so as to be positioned close to the entrance of an ear canal when the earpiece 100 is worn by a user. The sounds detected by the feedback microphone 120 are used as a reference from which feedback anti-noise sounds are derived and then acoustically output into the cavity 112 by the acoustic driver 190. The derivation of the feedback anti-noise sounds takes into account the characteristics and position of the acoustic driver 190 relative to the feedback microphone 120, and/or the acoustic characteristics of the cavity 112 and/or the passage 117. The feedback anti-noise sounds are acoustically output by the acoustic driver 190 with amplitudes and time shifts calculated to acoustically interact with noise sounds of the acoustic noise source 9900 that are able to enter into the cavity 112, the passage 117 and/or the ear canal (despite whatever PNR is provided) in a subtractive manner that at least attenuates them.

Each of the personal ANR devices 1000a and 1000b further incorporates one of the ANR circuit 2000 associated with each earpiece 100 such that there is a one-to-one correspondence of ANR circuits 2000 to earpieces 100. Either a portion of or substantially all of each ANR circuit 2000 may be disposed within the casing 110 of its associated earpiece 100. Alternatively and/or additionally, a portion of or substantially all of each ANR circuit 2000 may be disposed within another portion of the personal ANR device 1000. Depending on whether one or both of feedback-based ANR and feedforward-based ANR are provided in an earpiece 100 associated with the ANR circuit 2000, the ANR circuit 2000 is coupled to one or both of the feedback microphone 120 and the feedforward microphone 130, respectively. The ANR circuit 2000 is further coupled to the acoustic driver 190 to cause the acoustic output of ANR anti-noise sounds.

FIG. 2a depicts an “over-the-head” physical configuration 1500a that may be adopted by either of the personal ANR devices 1000a or 1000b. The physical configuration 1500a incorporates a pair of earpieces 100 that are each in the form of an earcup, and that are connected by a headband 102. However, and although not specifically depicted, an alternate variant of the physical configuration 1500a may incorporate only one of the earpieces 100 connected to the headband 102. Another alternate variant of the physical configuration 1500a may replace the headband 102 with a different band structured to be worn around the back of the head and/or the back of the neck of a user.

In the physical configuration 1500a, each of the earpieces 100 may be either an “on-ear” (also commonly called “supra-aural”) or an “around-ear” (also commonly called “circum-aural”) form of earcup, depending on their size relative to the pinna of a typical human ear. As previously discussed, each earpiece 100 has the casing 110 in which the cavity 112 is formed, and that 110 carries the ear coupling 115. In this physical configuration, the ear coupling 115 is in the form of a flexible cushion (possibly ring-shaped) that surrounds the periphery of the opening into the cavity 112 and that has the passage 117 formed therethrough that communicates with the cavity 112.

Portions of the casing 110 and/or of the ear coupling 115 cooperate to engage portions of the pinna of a user's ear and/or portions of a user's head surrounding the pinna to enable the casing 110 to be aligned with the entrance of the ear canal in an orientation that acoustically couples the cavity 112 with the ear canal through the ear coupling 115. Thus, when the earpiece 100 is properly positioned, the entrance to the ear canal is substantially “covered” to create some degree of acoustic seal that provides some degree of PNR.

FIG. 2b depicts an “in-ear” (also commonly called “intra-aural”) physical configuration 1500b that may be adopted by either of the personal ANR devices 1000a or 1000b. The physical configuration 1500b incorporates a pair of earpieces 100 that are each in the form of an in-ear earphone, and that may or may not be connected by a cord and/or by electrically or optically conductive cabling (not shown). However, and although not specifically depicted, an alternate variant of the physical configuration 1500b may incorporate only one of the earpieces 100.

Portions of the casing 110 and/or of the ear coupling 115 cooperate to engage portions of the concha and/or the ear canal of a user's ear to enable the casing 110 to rest in the vicinity of the entrance of the ear canal in an orientation that acoustically couples the cavity 112 with the ear canal through the ear coupling 115. Thus, when the earpiece 100 is properly positioned, the entrance to the ear canal is substantially “plugged” to create some degree of acoustic seal that provides some degree of PNR.

Although not specifically depicted, other variants of either of the physical configurations 1500a and 1500b may further incorporate one or more communications microphones to enable embodiments of either of the personal ANR devices 1000a and 1000b to support two-way communications, in addition to providing ANR. More specifically, a variant of the physical configuration 1500a (i.e., a headset) may provide a communications microphone supported at the end of microphone boom coupled to an earpiece 100 to be positioned in the vicinity of a user's mouth. Further, a variant of the physical configuration 1500b (i.e., a wireless form of headset, also known as an earset) may provide a communications microphone disposed on an enlarged variant of the casing 110 of an earpiece 100 in a manner positioning the communications microphone somewhat closer to a user's mouth.

FIG. 3a is a block diagram of at least a portion of the internal architecture of the ANR circuit 2000a of the personal ANR device 1000a, which as previously discussed, provides feedforward-based ANR, but not feedback-based ANR. The ANR circuit 2000a incorporates a compression circuit 3000, a feedforward anti-noise generator 350, and an audio amplifier 980.

The compression circuit 3000 receives a signal from the feedforward microphone 130 representing sounds in the environment external to the casing 110 (such as noise sounds emanating from the acoustic noise source 9900) that are detected by the feedforward microphone 130. As will be explained in greater detail, the compression circuit 3000 simply passes along a signal representing that same signal received from feedforward microphone 130 to the feedforward anti-noise generator 350 as long as the acoustic level of those sounds does not become so high that the feedforward microphone 130 is unable to output a signal having a voltage level that is linearly related to the acoustic level of those sounds.

However, where those sounds do reach such a high enough acoustic level, the electric signal output by the feedforward microphone 130 ceases to linearly represent the sounds detected by the feedforward microphone 130 (i.e., microphone distortion is occurring), and that electric signal may exhibit clipping. In such a situation, the compression circuit 3000 provides the feedforward anti-noise generator with a signal representative of this non-linear electric signal output of the feedforward microphone 130, but considerably attenuated as a result of compression being provided by the compression circuit 3000. Since the electric signal output by the feedforward microphone 130 represents sounds detected by the feedforward microphone 130, regardless of whether the voltage levels of that signal are linearly related to the acoustic levels of those sounds or not, the attenuation of the signal output by the compression circuit 3000 represents a compression of those sounds represented by the electric signal output by the feedforward microphone 130. The feedforward anti-noise generator 350 employs whatever signal it receives from the compression circuit 3000 (i.e., with or without compression being provided) as a feedforward reference signal from which to generate feedforward anti-noise sounds through one or more techniques that will be familiar to those skilled in the art of feedforward-based ANR. The feedforward anti-noise generator 350 then outputs a signal representing those feedforward anti-noise sounds to the audio amplifier 980 to be amplified to an extent necessary to drive the acoustic driver 190 to acoustically output those feedforward anti-noise sounds into the cavity 112.

FIG. 3b is a block diagram of at least a portion of the internal architecture of the ANR circuit 2000b of the personal ANR device 1000b, which as previously discussed, provides both feedforward-based and feedback-based ANR. The ANR circuit 2000b is substantially similar to the ANR circuit 2000a, and incorporates the compression circuit 3000, the feedforward anti-noise generator 350 and the audio amplifier 980 to provide feedforward-based ANR in substantially the same manner as the ANR circuit 2000a. However, the ANR circuit 2000b further incorporates a feedback anti-noise generator 250 and a summing node 970.

The feedback anti-noise generator 250 receives a signal from the feedback microphone 120 representing sounds in the cavity 112 (such as noise sounds that have propagated from the acoustic noise source 9900 and into the cavity 112, and that have not been entirely countered by the provision of ANR and/or PNR) that are detected by the feedback microphone 120. The feedback anti-noise generator 250 employs whatever signal it receives from the feedback microphone 120 as a reference signal from which to generate feedback anti-noise sounds through one or more techniques that will be familiar to those skilled in the art of feedback-based ANR. Both the feedforward anti-noise generator 350 and the feedback anti-noise generator 250 output signals representing feedforward anti-noise sounds and feedback anti-noise sounds, respectively, to the summing node 970 to be combined and relayed to the audio amplifier 980 to be amplified to an extent necessary to drive the acoustic driver 190 to acoustically output the combined anti-noise sounds into the cavity 112.

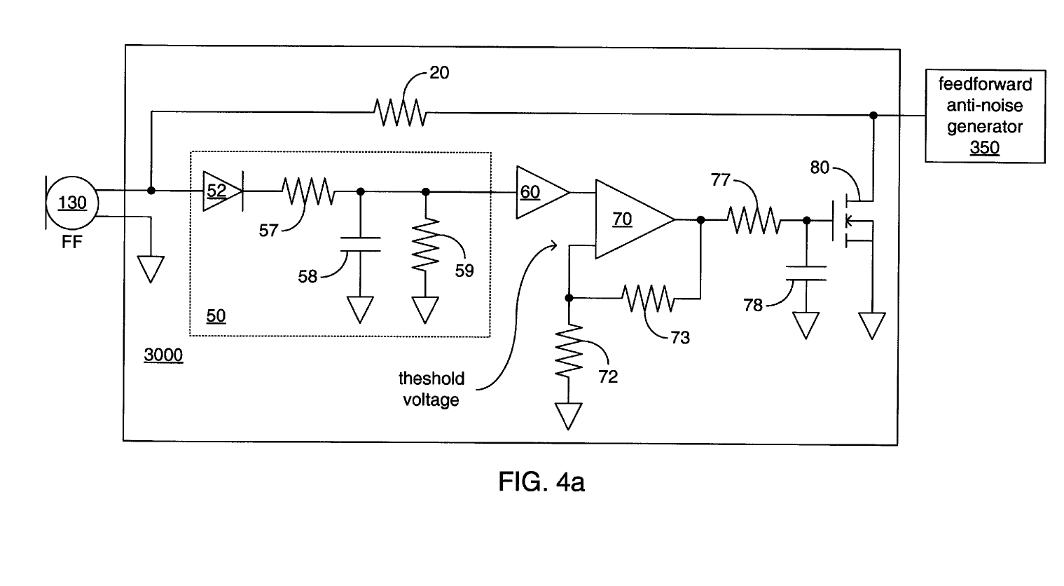

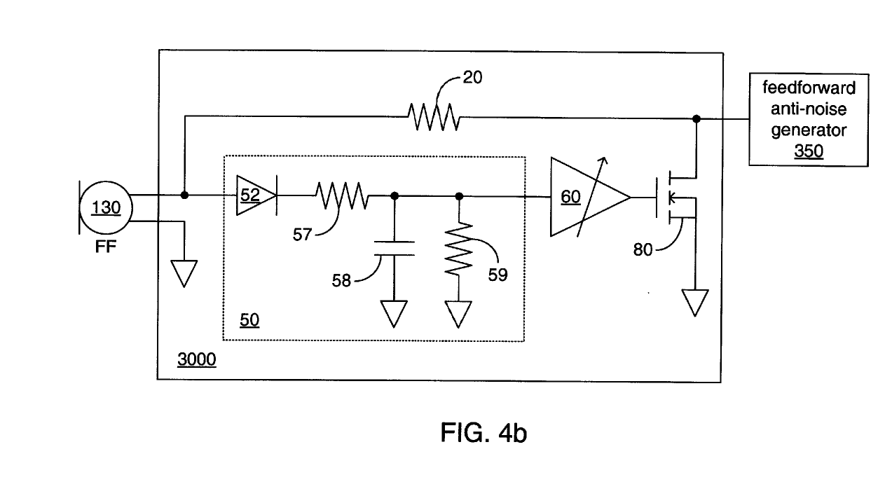

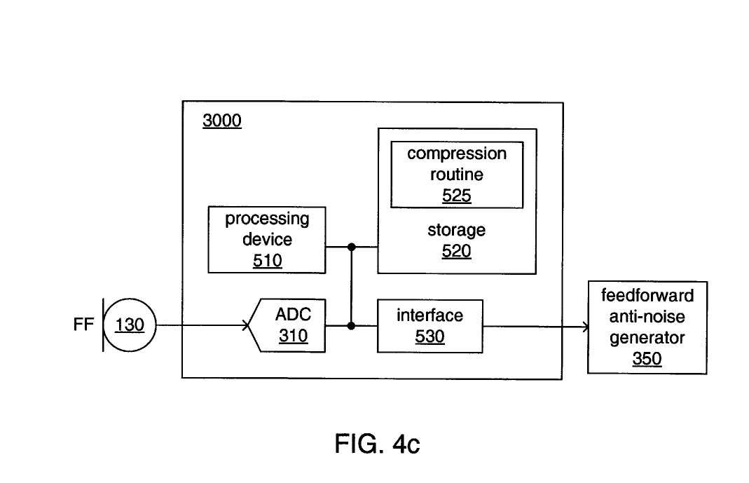

FIG. 4a is a diagram of a possible analog implementation of the compression circuit 3000 in which both the signal received from the feedforward microphone and the signal provided to the feedforward anti-noise generator 350 are analog signals. This implementation of the compression circuit 3000 incorporates resistors 20, 57, 59, 72, 73 and 77; a diode 30; capacitors 58 and 78; an amplifier 60; a comparator 70 and a MOSFET 80.

The resistor 20 is coupled in series to the output of the feedforward microphone 130 and the input of the feedforward anti-noise generator 350 such that the analog signal received from the feedforward microphone 130 is allowed to pass through the compression circuit 3000 to the feedforward anti-noise generator 350 through the resistor 20. The output of the feedforward microphone 130 is also coupled to the anode of the anode of the diode 30, of which the cathode is coupled to the resistor 57. In turn, the resistor 57 is coupled to the capacitor 58 and the resistor 59, both of which are further coupled to ground, thereby forming an RC network. The output of this RC network is coupled to the input of the amplifier 60, the output of which is coupled to one of the inputs of the comparator 70. A threshold voltage is provided to the other input of the comparator 70. The output of the comparator 70 is coupled to the resistors 73 and 77. In turn, the resistor 73 is further coupled to the other input of the comparator 70, and to the resistor 72, which is further coupled to ground. Also in turn, the resistor 77 is coupled to the capacitor 78, which is further coupled to ground, thereby forming another RC network. The output of this other RC network is coupled to the gate of the MOSFET 80. The source of the MOSFET 80 is grounded and the drain is coupled to the input of the feedforward anti-noise generator 350 (and thereby also coupled to the resistor 20).

The diode 52, the resistors 57 and 59, and the capacitor 58 cooperate to form an envelope detector 50. Within the envelope detector 50, the diode 52 cooperates with the capacitor 58 to form a peak detector, and the capacitor 58 cooperates with the resistors 57 and 59 to form an integrator. As the feedforward microphone 130 outputs electric signals representing sounds, the diode 52 and the capacitor 58 cooperate as a peak detector to store a charge having a voltage level corresponding to the highest voltage levels of the peaks in the electric signal output by the feedforward microphone 130. However, the manner in which that charge is stored and subsequently discharged is controlled by the cooperation of the capacitor 58 and the resistors 57 and 59 as an integrator, wherein the resistor 57 provides control over the rate of storage of the charge (i.e., rate of charging), and the resistor 59 provides control over the rate of discharge of the charge. As a result, the charge and discharge occur at rates that allow the voltage level of the charge maintained by the capacitor 58 to tend to follow the voltage peaks of the signal output by the feedforward microphone 130, to not be discharged with every valley of the signal output by the feedforward microphone 130. This integrated variant of the peaks of the signal output by the feedforward microphone 130 is provided to the amplifier 60.

The comparator 70 receives the output of the amplifier 60 and compares that output to the threshold voltage provided to the other input of the comparator 70. The threshold voltage is at least partly determined by the choice of the resistors 72 and 73. The output of the comparator 70 transitions between a high state and a low state depending on the results of comparing the voltage levels of the output of the amplifier 60 and the provided threshold voltage. The voltage level that must be reached by the electric signal output by the feedforward microphone 130 to cause the triggering of compression are set by the gain of the amplifier 60 and the voltage level of the threshold voltage provided to the comparator 70, and that voltage level of the signal output by the feedforward microphone 130 may be selected to be just below, substantially at, or just above the voltage level at which clipping occurs in the signal output by the feedforward microphone 130. Indeed, in some embodiments, the voltage level of the output of the feedforward microphone 130 that triggers compression may be made dynamically configurable by making provisions to dynamically configure the threshold voltage provided to the comparator 70 (perhaps by making the resistance of one or both of the resistors 72 and 73 variable) to accommodate the use of any of a variety of different microphones as the feedforward microphone 130. The output of the comparator 70 is provided to the gate of the MOSFET 80 through the RC network formed by the resistor 77 and the capacitor 78. It is the voltage level of the signal that reaches the gate of the MOSFET 80 that triggers the compression circuit 3000 to either provide or not provide compression.

The RC network formed by the resistor 77 and the capacitor 78 serves as a second integrator and cooperates with the resistors 72 and 73 to both smooth out the transitions in the output of the comparator 70 to smooth the onset and cessation of the compression provided by the compression circuit 3000, and to provide at least some degree of hysteresis in switching between the compression circuit 3000 providing and not providing compression. Such smoothing of the transitions between the compression circuit 3000 providing and not providing compression may be deemed desirable to avoid causing sharp changes in the signal provided to the feedforward anti-noise generator, which might cause the generation of artifacts in the anti-noise sounds that might be audible to a user. Further, the provision of such hysteresis may be deemed desirable to avoid instances of frequent switching between providing and not providing compression as a result of a rapid series of small envelope variations in the output of the envelope detector 50, which may also generate audible artifacts.

During normal operation of either of the ANR circuits 2000a and 2000b where environmental noise sounds do not reach very high acoustic levels, the electric signal output by the feedforward microphone 130 is conveyed by the compression circuit 3000 through the resistor 20 to the input of the feedforward anti-noise generator 350 with little or no change. More specifically, the lack of very high acoustic levels in the environmental noise sounds detected by the feedforward microphone 130 result in the feedforward microphone 130 generating an electrical output having peaks that are not of very high voltage levels. As a result, the charge stored by the capacitor 58 does not reach a voltage level that causes the comparator 70 to be provided with an output by the amplifier 60 having a voltage higher than the threshold voltage also provided to the comparator 70, and thus, the compression circuit 3000 is not triggered to provide compression.

However, on occasions where environmental sounds encountered by the feedforward microphone 130 do exceed a chosen acoustic level, the feedforward microphone 130 electrically outputs a signal that exceeds a predetermined voltage level relative to the ground to which the feedforward microphone 130 is referenced, and above which clipping may occur as the voltage of the electrical output of the feedforward microphone 130 ceases to have a linear relationship to the acoustic input detected by the feedforward microphone 130. The peaks of the higher voltage of the electric signal output of the feedforward microphone 130 are conveyed through the diode 30 and the resistor 57, and are stored in the capacitor 58. Again, the resistor 57 slows the rate at which the capacitor 58 is charged up to the voltage level of these peaks, and the resistor 59 controls the rate at which the capacitor 58 is discharged so as to cause the voltage level stored by the capacitor 58 to represent an integral of the voltage levels of the individual peaks. The voltage level stored by the capacitor is provided to the input of the amplifier 60, and the amplifier 60 conveys those higher voltages with a preselected degree of gain to the comparator 70. Presuming that the voltage level of the output of the amplifier 60 is higher than the voltage level of the threshold voltage also provided to the comparator 70, the output of the comparator 70 transitions to a state that causes the resistance between the source and drain of the MOSFET 80 to be reduced as this transitioning output of the comparator 70 is provided to the gate of the MOSFET 80. This reduction in the resistance between the source and the drain of the MOSFET 80 places the input of the feedforward anti-noise generator amidst a voltage divider formed between the resistor 20 and the MOSFET 80 whereby the voltage of the signal received by the anti-noise generator 350 is reduced. In this way, the electric signal output by the feedforward microphone 130 is compressed. When the succession of very high voltage level peaks in the signal output by the feedforward microphone 130 cease, the level of the voltage stored by the capacitor 58 drops, eventually causing the voltage level of the output of the amplifier 60 eventually to drop below the voltage level of the threshold voltage, thereby causing the output of the comparator 70 to transition again, and thereby causing the MOSFET 80 to once again increase the resistance between its source and drain such that compression ceases to be provided. Again, the resistor 77 and the capacitor 78 cooperate to smooth these transitions of the output of the comparator 70 and to provide some degree of hysteresis, thereby smoothing the changes in resistance between the source and drain of the MOSFET 80 to avoid creating sharp transitions in the electric signal provided to the feedforward anti-noise generator 350 and aiding in preventing changes in that resistance from occurring too frequently.

FIG. 4b is a diagram of another possible analog implementation of the compression circuit 3000 in which both the signal received from the feedforward microphone and the signal provided to the feedforward anti-noise generator 350 are analog signals. The analog implementation depicted in FIG. 4b is substantially similar to what was depicted in FIG. 4a. However, in the implementation depicted in FIG. 4b, the comparator 70; the resistors 72, 73 and 77; and the capacitor 78 are removed; and the output of the amplifier 60 is provided directly to the gate of the MOSFET 80. The removal of the comparator 70 removes the need for the RC network created by the resistor 77 and the capacitor 78, as well as the need for the resistors 72 and 73, to smooth the signal provided to the gate of the MOSFET 80 and to provide hysteresis. Instead, the integration function performed by the cooperation of the capacitor 58 with the resistors 57 and 59 can be relied upon to provide such smoothing, and the MOSFET 80 can be chosen to have gate characteristics, such as the gate threshold voltage, that are sufficiently tightly controlled as to remove much of the need for the provision of hysteresis in the signal provided to the gate of the MOSFET 80. In particular, examples of preferred MOSFETs having a desirable degree of accuracy in such characteristics as the gate threshold voltage are the ALD110808, ALD110808A, ALD110908 and ALD110908A available from Advanced Linear Device, Inc. of Sunnyvale, Calif. The removal of the comparator 70 also removes the ability to use a threshold voltage to dynamically configure the voltage level of the electric signal output by the feedforward microphone 130 at which compression is triggered. However, such configurability may still be provided by selecting a form of the amplifier 60 having a variable gain.

FIG. 4c is a diagram of a possible digital implementation of the compression circuit 3000 in which an analog signal received from the feedforward microphone 130 is converted into digital data representing the analog signal (and which is thereby representative of the sounds detected by the feedforward microphone 130), and the feedforward anti-noise generator 350 is subsequently provided with digital data. This implementation of the compression circuit 3000 incorporates an analog-to-digital converter (ADC) 310, a processing device 510, a storage 520 and an interface 530, all of which are interconnected by any of a variety of possible buses and bus interface circuitry as will be readily understood by those skilled in the art, by which at least the processing device 510 is able to access at least storage locations within the storage 520.

The processing device 510 may be any of a variety of types of processing device, including and not limited to, a general purpose central processing unit (CPU), a reduced instruction set computer (RISC), a digital signal processor (DSP), a microcontroller, a sequencer or discrete logic. The storage 520 may be any of a variety of types of storage device or devices, including and not limited to, volatile and/or nonvolatile forms of solid-state memory, magnetic and/or optical storage media, biochemical storage or printed record.

Stored within the storage 520 is a compression routine 525. Upon being executed by the processing device 510, the compression routine 525 causes the processing device to operate the ADC 310 to repeatedly sample and convert an analog signal received from the feedforward microphone 130 into digital data representing that analog signal. The processing device 510 is further caused to analyze one or more characteristics of that analog signal, as represented by the digital data from the ADC 310, and to selectively alter the digital data to create modified digital data representing an attenuated form of that analog signal (and thereby representing a compressed form of the sounds detected by the feedforward microphone 130), if triggered to do so in response to the analysis. The processing device 510 is still further caused to operate the interface 530 to relay digital data to the feedforward anti-noise generator 350. If the processing device 510 is triggered to alter the digital data, then the processing device 510 operates the interface 530 to provide the feedforward anti-noise generator 350 with the modified digital data. However, if the processing device 510 is not triggered to alter the digital data, then the processing device 510 operates the interface 530 to relay the digital data from the ADC 310 to the feedforward anti-noise generator 350, substantially unaltered.

In one variation, the manner in which the processing device 510 is triggered to perform compression is not unlike the trigger earlier described with regard to an analog implementation of the compression circuit 3000. Specifically, the processing device 510 monitors the magnitude of the digital values of the digital data representing the peaks in the analog signal received from the feedforward microphone 130 for indications of a predetermined voltage of that signal being exceeded, and altering the digital data to attenuate the signal to thereby provide compression. However, in an alternative variation, the processing device 510 may analyze the shape of the analog signal represented by the digital data for indications of clipping or other indications of non-linearity in the relationship between the acoustic level of sounds detected by the feedforward microphone 130 and its electrical output of a signal. The processing device 510 may then be triggered to provide compression in response to such instances of clipping or other form of non-linearity. Further, in still another alternative variation, the processing device 510 may analyze the shape of the analog signal represented by the digital data, and provide compression in response to observing an instance of an increase in voltage occurring with a sufficiently great magnitude within a sufficiently small period of time that it is apparent that the signal is about to become non-linear.

It should be noted that in an alternate digital implementation of the compression circuit 3000, an equivalent of the feedforward anti-noise generator 350, and possibly an equivalent of the feedback anti-noise generator 250 are implemented through execution of a feedforward anti-noise routine (not shown) and a feedback anti-noise routine (not shown), respectively, that are also stored within the storage 520 and also executed by the processing device 510. Such an alternate implementation of the compression circuit 3000 may further incorporate a digital-to-analog converter (DAC) to convert the resulting digital data representing anti-noise sounds into an analog signal representing anti-noise sounds to be provided to the audio amplifier 980. Thus, the creation of anti-noise sounds would also be accomplished in the digital domain.

Other implementations are within the scope of the following claims and other claims to which the applicant may be entitled.

1. A method of providing feedforward-based ANR in an earpiece of a personal ANR device, the method comprising:
monitoring a voltage level of an electric signal output by a feedforward microphone disposed on an external portion of the personal ANR device, wherein the electric signal is representative of environmental noise sounds detected by the feedforward microphone;
providing the environmental noise sounds detected by the feedforward to a feedforward anti-noise generator as feedforward reference sounds to provide the feedforward-based ANR; and
compressing the environmental noise sounds prior to providing the environmental noise sounds to the anti-noise generator in response to peaks in the voltage level of the electric signal output by the feedforward microphone reaching a predetermined voltage level.

2. The method of claim 1, further comprising selecting the predetermined voltage level to trigger the compressing of the environmental sounds during instances of clipping of the electric signal.

3. The method of claim 1, wherein monitoring the electric signal comprises providing the electric signal to an envelope detector comprising a peak detector and an integrator.

4. The method of claim 3, wherein compressing the environmental noise sounds comprises:
triggering the compressing of the environmental noise sounds based on the voltage level of the output of the envelope detector; and
reducing the voltage level of the electric signal output by the feedforward microphone.

5. The method of claim 1, further comprising converting the electric signal output by the feedforward microphone into digital data that is representative of the environmental noise sounds detected by the feedforward microphone.

6. The method of claim 5, wherein compressing the environmental noise sounds comprises:
triggering the compressing of the environmental noise sounds based on the digital data providing indication of peaks in the voltage level of the electric output reaching the predetermined voltage level; and
altering the digital data to compress the environmental noise sounds represented by the digital data prior to the digital data being employed in generating feedforward anti-noise sounds.

7. An apparatus comprising an ANR circuit, the ANR circuit comprising:
a feedforward anti-noise generator to generate feedforward anti-noise sounds as part of providing feedforward-based ANR; and
a compression circuit to monitor an electric signal output by a feedforward microphone that is representative of environmental noise sounds detected by the feedforward microphone, and to compress the environmental noise sounds prior to providing the environmental noise sounds to the anti-noise generator as feedforward reference sounds in response to peaks in a voltage level of the electric signal.

8. The apparatus of claim 7, wherein the ANR circuit further comprises:
a peak detector to store a voltage level of a peak of the electric signal; and
an integrator to provide an output representing an integral of a plurality of peaks of the electric signal.

9. The apparatus of claim 8, wherein the ANR circuit further comprises a comparator to compare voltage levels including a voltage level of a threshold voltage that is dynamically configurable to enable a voltage level of a peak in the electric signal that triggers compression to be dynamically configured to accommodate a changing of the feedforward microphone.

10. The apparatus of claim 8, wherein the ANR circuit further comprises an amplifier to which the output of the integrator is provided, and provided with a variable gain that is dynamically configurable to enable a voltage level of a peak in the electric signal that triggers compression to be dynamically configured to accommodate a changing of the feedforward microphone.

11. The apparatus of claim 7, wherein the ANR circuit further comprises:
an ADC to convert the electric signal to digital data representative of the environmental noise sounds detected by the feedforward microphone;
a processing device; and
a storage in which is stored a sequence of instructions of a compression routine that when executed by the processing device, causes the processing device to alter the digital data to compress the environmental noise sounds represented by the digital data prior to the digital data being employed in generating feedforward anti-noise sounds.

12. The apparatus of claim 11, wherein the processing device is further caused to generate the feedforward anti-noise sounds.

13. The apparatus of claim 7, further comprising:
an earpiece;
the feedforward microphone;
an audio amplifier to amplify the feedforward anti-noise sounds generated by the feedforward anti-noise generator; and
an acoustic driver disposed within the earpiece and coupled to the audio amplifier to acoustically output the feedforward anti-noise sounds.

14. The apparatus of claim 13, further comprising:
a feedback microphone disposed within the earpiece;
a feedback anti-noise generator to generate feedback anti-noise from sounds detected by the feedback microphone; and
a summing node to combine the feedforward anti-noise sounds and the feedback anti-noise sounds to be acoustically output by the acoustic driver.
